(19) United States
(12) Patent Application Publication
(10) Pub. No.: US 2013/0070034 A1
(43) Pub. Date: Mar. 21, 2013

(54) LIQUID EJECTING HEAD AND LIQUID EJECTING APPARATUS

(71) Applicants: Shushi Makita, Matsumoto-shi (JP); Kinya Ozawa, Shiojiri-shi (JP)

(72) Inventors: Shushi Makita, Matsumoto-shi (JP); Kinya Ozawa, Shiojiri-shi (JP)

(73) Assignee: SEIKO EPSON CORPORATION, Tokyo (JP)

(21) Appl. No.: 13/612,699

(22) Filed: Sep. 12, 2012

(30) Foreign Application Priority Data
Sep. 15, 2011 (JP) 2011-201473

(51) Int. Cl. B41J 2/175

(52) U.S. Cl. 347/85; 347/86

(57) ABSTRACT

Disclosed herein is a liquid ejecting head in which a liquid is able to be filled in a pressure chamber communicated with a nozzle opened in a nozzle plate and droplets are able to be ejected from the nozzle by applying a change in pressure of the liquid in the pressure chamber. The pressure chamber has a deformation portion which is deformed based on the change in the pressure of the liquid in the pressure chamber, in at least a portion of a bottom thereof.

### The entire disclosure of Japanese Patent Application No. 2011-201473, filed Sep. 15, 2011 is expressly incorporated by reference herein.

### BACKGROUND

1. Technical Field

The present invention relates to a liquid ejecting head for an ink jet type recording apparatus or the like and a liquid ejecting apparatus having the same, and more particularly, to a liquid ejecting head and a liquid ejecting apparatus capable of ejecting a liquid which contains particles such as pigments from a nozzle.

2. Related Art

As a liquid ejecting head which discharges droplets from a nozzle opening by causing a change in pressure of a liquid in a pressure chamber, there are, for example, an ink jet type recording head (hereinafter, simply referred to as a recording head) used for an image recording apparatus such as a printer, a color material ejecting head used to manufacture a color filter for a liquid crystal display or the like, an electrode material ejecting head used to form an electrode for an organic EL (Electro-Luminescent) display, an FED (Field Emission Display), or the like, a bio-organic substance ejecting head used to manufacture a biochip (biochemical device), and the like.

The liquid used for the liquid ejecting head includes a solvent which contains particles. For example, there is a pigment dispersion-based ink (hereinafter, referred to as a pigment ink) in which pigments are used as coloring matters and are dispersed in an ink solvent. There is a problem in that pigments are settled (precipitated) when the pigment ink is left for a long period of time. Particularly, metal-based pigments easily tend to be settled. When pigments are settled, not only may the concentration of the pigments in the discharged droplets vary, but also may the nozzles clog up.

To solve these problems, it has been proposed that a circulation passage is provided in a recording head and an ink in a pressure chamber is circulated (for example, see JP-A-2008-284739). Thereby, the settled pigments may be agitated.

However, the recording head has a complicated structure since the circulation passage is provided in the recording head. Also, the recording head needs a separate drive source to circulate the ink. For this reason, costs or the size of the apparatus may be increased in terms of manufacture of the recording head.

### SUMMARY

An advantage of some aspects of the invention is to provide a liquid ejecting head and a liquid ejecting apparatus capable of simply agitating a liquid in a pressure chamber, with no need to provide a separate drive source.

According to an aspect of the invention, a liquid ejecting head is provided in which a liquid is able to be filled in a pressure chamber communicated with a nozzle and droplets are able to be ejected from the nozzle by applying a change in pressure of the liquid in the pressure chamber, wherein the pressure chamber has a deformation portion which is deformed based on the change in the pressure of the liquid in the pressure chamber, in at least a portion of a bottom thereof.

According to the liquid ejecting head of the invention, since the deformation portion of the bottom is changed by the change in the pressure of the liquid in the pressure chamber, the liquid in the pressure chamber is agitated by the change of the deformation portion. As a result, pigments and the like may be prevented from being settled without provision of a separate drive source. Also, even when the pigments and the like are settled at the bottom, the settled pigments and the like may be agitated.

In the above configuration, the bottom of the pressure chamber may be formed by a nozzle plate in which the nozzle is opened and a flexible vibration plate which is laminated in at least a portion between the nozzle plate and the pressure chamber. A concave portion may be formed in at least a portion corresponding to the pressure chamber in the nozzle plate. The deformation portion may be formed by sealing the concave portion with the vibration plate.

According to such a configuration, it may be possible to simply realize a configuration to agitate the pigments and the like which are settled at the bottom.

In addition, the bottom of the pressure chamber may be formed by a nozzle plate in which the nozzle is opened. The deformation portion may be formed of a section having a thinner thickness than the other section in the nozzle plate.

According to such a configuration, since there may be no need to form the deformation portion by adding a new member and the like to the liquid ejecting head of the related art, it may be possible to further simply realize the configuration to agitate the pigments and the like which are settled at the bottom.

According to another aspect of the invention, a liquid ejecting apparatus includes the liquid ejecting head according to each of the above configurations.

### BRIEF DESCRIPTION OF THE DRAWINGS

The invention will be described with reference to the accompanying drawings, wherein like numbers reference like elements.

FIG. 1 is a perspective view illustrating a printer.

FIG. 2 is an exploded perspective view for explaining a configuration of a recording head.

FIG. 3A is a sectional view illustrating a principal portion of a recording head according to a first embodiment.

FIG. 3B is a sectional view taken along line IIIB-IIIB of FIG. 3A.

FIG. 4 is a schematic diagram illustrating agitation of pigments.

FIG. 5 is a sectional view illustrating a principal portion of a recording head according to a second embodiment.

### DESCRIPTION OF EXEMPLARY EMBODIMENTS

Hereinafter, embodiments of the invention will be described with reference to the accompanying drawings. Although the embodiments described below are limited to various specific preferred embodiments of the invention, the scope of the invention is not limited thereto unless the invention is otherwise limited in the following description. Hereinafter, an ink jet type recording apparatus 1 (hereinafter, referred to as a printer), by way of example, will be described as a liquid ejecting apparatus of the invention.

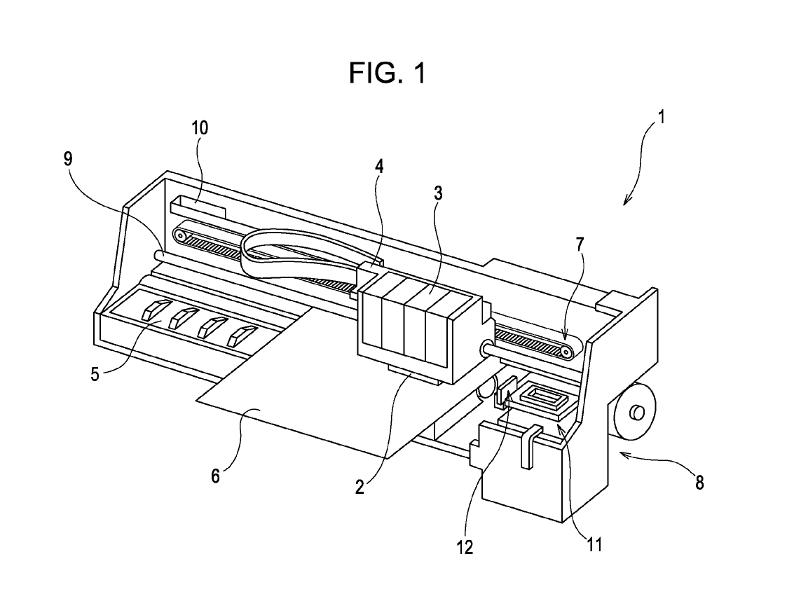

FIG. 1 is a perspective view illustrating a configuration of a printer 1. The printer 1 includes a carriage 4, to which a recording head 2 which is a kind of liquid ejecting head is mounted and an ink cartridge 3 which is a kind of liquid supply source is detachably mounted, a platen 5 which is arranged below the recording head 2 during a recording operation, a carriage moving mechanism 7 to reciprocate the carriage 4 in a paper width direction of, namely, in a main scanning direction of recording paper 6 (which is a kind of recording medium and impacted target), and a transport mechanism 8 to transport the recording paper 6 in a sub-scanning direction perpendicular to the main scanning direction.

The carriage 4 is mounted in a state of being axis-supported by a guide rod 9 installed in the main scanning direction, and is moved along the guide rod 9 in the main scanning direction by an operation of the carriage moving mechanism 7. A linear encoder 10, which is a kind of position information detection unit, detects a position of the carriage 4 in the main scanning direction thereof, and transmits a detected position signal, namely, an encoder pulse (which is a kind of position information) to a controller of the printer 1.

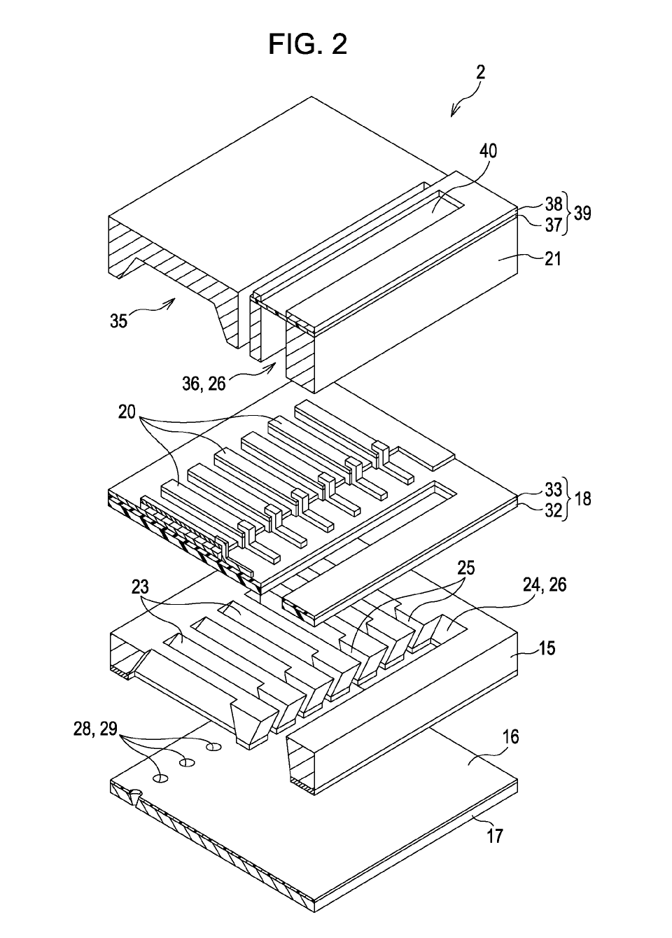

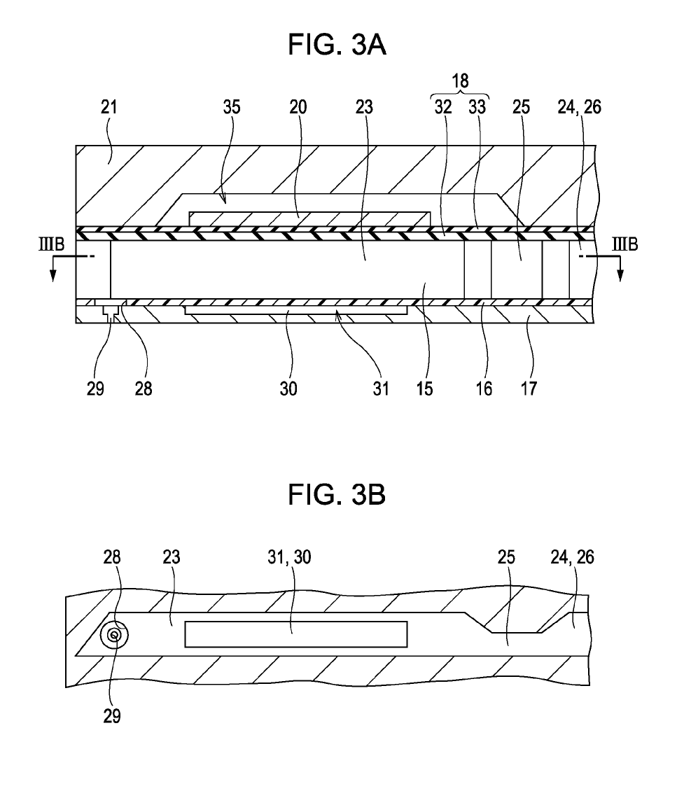

Also, a home position which is a starting point of scanning of the carriage 4 is set at an end region outside a recording region within a movement range of the carriage 4. In the embodiment, the home position is disposed with a capping member 11 to seal a nozzle forming surface (a nozzle plate 17: see FIGS. 2 and 3) of the recording head 2 and a wiper member 12 to sweep the nozzle forming surface. The printer 1 performs a so-called bi-directional recording process which records characters, images, or the like on the recording paper 6 by bi-directional movement of the carriage 4, that is forward movement in which the carriage 4 is moved from the home position toward an end side opposite to the home position and backward movement in which the carriage 4 is returned from the opposite end side to the home position.

Next, the recording head 2 will be described.

FIG. 2 is an exploded perspective view illustrating a configuration of the recording head 2 according to the embodiment. FIG. 3A is a sectional view illustrating a principal portion of the recording head 2. FIG. 3B is a sectional view taken along line IIIB-IIIB of FIG. 3A. The recording head according to the embodiment includes a passage forming substrate 15, a lower vibration plate 16, a nozzle plate 17, an upper vibration plate 18, piezoelectric devices 20, a protective substrate 21, and the like, and these are configured to be laminated.

The passage forming substrate 15 is made of a silicon single crystal substrate in the embodiment. The passage forming substrate 15 is provided with a plurality of pressure chambers 23 in parallel with one another in a width direction of each thereof. Each of the pressure chambers 23 is an empty section which is elongated in a direction perpendicular to a nozzle row. The pressure chamber 23 is sealed, at an upper portion thereof, with the upper vibration plate 18 while being sealed, at a lower portion thereof, with the lower vibration plate 16 (as will be described later). The upper vibration plate 18 is deformed by driving each of the piezoelectric devices 20 to be described later to allow the associated pressure chamber 23 to have a capacity which is increased and decreased. A communication portion 24 is formed at a region outside the pressure chambers 23 of the passage forming substrate 15 in a longitudinal direction of each thereof. The communication portion 24 and the pressure chambers 23 are communicated through ink supply passages 25 provided at the respective pressure chambers 23. Each of the ink supply passages 25 has a smaller width than each pressure chamber 23, thereby uniformly maintaining passage resistance of an ink which is introduced from the communication portion 24 to the pressure chamber 23. Moreover, the communication portion 24 is communicated with a common chamber 36 of the protective substrate 21 to be described later to constitute a portion of a reservoir 26 which becomes a common ink chamber of each pressure chamber 23.

The lower vibration plate 16 (corresponding to the vibration plate in the invention) which constitutes the bottom of each pressure chamber 23 and the nozzle plate 17 are laminated, in this order, on and bonded to a side (lower side) of an opening surface of the passage forming substrate 15. The lower vibration plate 16 is a thin sheet material (film material) having flexibility. In the embodiment, the lower vibration plate 16 is made of, for example, silicon dioxide (SiO₂) of approximately 1.0 μm in thickness. The lower vibration plate 16 is laminated on an entire surface of a pressure chambers 23 side of the nozzle plate 17. Moreover, the lower vibration plate 16 is not limited to being formed on the entire surface of the nozzle plate 17, but may be formed on at least a portion (which is a portion corresponding to the pressure chamber 23) of the surface of the pressure chambers 23 side of the nozzle plate 17. In addition, communication holes 28 are respectively formed at portions corresponding to nozzles 29 (to be described later) of the lower vibration plate 16, and the pressure chamber 23 are communicated with the nozzles 29 through the communication holes 28, respectively.

The nozzle plate 17 is made of a silicon single crystal substrate or stainless steel, which has, for example, a thickness of approximately 0.1 to 1 mm, and is formed with the nozzles 29 corresponding to the respective pressure chambers 23. The nozzles 29 are communicated with end sides of the pressure chambers 23 opposite to the ink supply passages 25, respectively. Also, as shown in FIG. 3A, the nozzle plate 17 is formed with an empty portion 30 recessed in a direction opposite to each pressure chamber 23, at a portion of the section corresponding to each pressure chamber 23 on the surface of the lower vibration plate 16 side of the nozzle plate 17. As shown in FIG. 3B, the empty portion 30 of the embodiment is formed in a rectangular shape (that is, a concave portion of a rectangular parallelepiped shape) along the longitudinal direction of the pressure chamber 23 when viewed from the top, between each ink supply passage 25 and each nozzle 29. A deformation portion 31 is provided by the lower vibration plate 16 to seal an opening portion of the empty portion 30. The empty portion 30 is designed as a shape and dimensions (capacity) capable of generating variation (deformation) of the lower vibration plate 16 in response to a change in pressure of a liquid in the pressure chamber 23. The lower vibration plate 16 is varied in response to the change in the pressure of the liquid in the pressure chamber 23, and thus pigments settled at the bottom of the pressure chamber 23 may be agitated. Agitating the pigments with deformation portion 31 will be described later. In addition, the empty portion 30 may also be formed by penetrating a portion of or an entire portion of the nozzle plate 17 in a thickness direction thereof. Furthermore, for example, the nozzle 29 and the empty portion 30 are formed by etching when the nozzle plate 17 is made of a silicon single crystal substrate, and the nozzle 29 and the empty portion 30 are formed by a press process when the nozzle plate 17 is made of stainless steel.

The upper vibration plate 18 is formed at a side (upper side) opposite to the opening surface of the passage forming substrate 15. The upper vibration plate 18 of the embodiment includes, for example, an elastic film 32 which is made of silicon dioxide (SiO₂) of, for example, approximately 1.0 μm in thickness, and an insulating film 33 which is laminated on the elastic film 32 and made of zirconium oxide (ZrO₂) of, for example, approximately 0.4 μm in thickness. Also, the plural piezoelectric devices 20 are arranged on the insulating film 33 so as to correspond to the respective pressure chambers 23. In the embodiment, each of the piezoelectric devices 20 is a vibrator of a flexural vibration mode, and has a piezoelectric body which is interposed between a drive electrode and a common electrode (not shown). When a drive signal is applied to the drive electrode of the piezoelectric device 20, an electric field is generated between the drive electrode and the common electrode in response to a potential difference therebetween. When this electric field is applied to the piezoelectric body, the piezoelectric body is deformed in response to the strength of the applied electric field.

In addition, the protective substrate 21 is bonded to a surface of a piezoelectric device 20 side on the passage forming substrate 15 in a state of interposing the upper vibration plate 18 therebetween, and the protective substrate 21 has a piezoelectric device holding portion 35 which is a space having the size with no hindrance of displacement of the piezoelectric devices 20 in a region facing the same. The piezoelectric devices 20 are protected in a state of being nearly unaffected by the external environment since being housed in the piezoelectric device holding portion 35. Furthermore, as shown in FIG. 2, the protective substrate 21 is provided with the common chamber 36 at a region corresponding to the communication portion 24 of the passage forming substrate 15. The common chamber 36 penetrates the protective substrate 21 in a thickness direction thereof and is provided along a direction parallel to the pressure chambers 23. The common chamber 36 is communicated with the communication portion 24 of the passage forming substrate 15, as described above, thereby constituting the reservoir 26 which becomes the common ink chamber of each pressure chamber 23.

Furthermore, a compliance substrate 39 includes a sealing film 37 and a fixed plate 38, and is bonded on the protective substrate 21. The sealing film 37 is made of a flexible material with low stiffness (for example, a polyphenylene sulfide film of 6 μm in thickness), and one side surface of the common chamber 36 is sealed by the sealing film 37. Also, the fixed plate 38 is made of a hard material such as metal (for example, stainless steel of 30 μm in thickness). Since a region of the fixed plate 38 which faces the reservoir 26 becomes a fixed plate opening portion 40 which is entirely removed in the thickness direction, one side surface of the reservoir 26 is sealed only by the sealing film 37 having flexibility.

In the recording head 2 having the above-mentioned configuration, after the ink in the ink cartridge 3 is introduced from an ink introduction passage which is not shown and is filled in an inner portion of the recording head 2 until reaching the nozzles 29 from the reservoir 26, the piezoelectric device 20 corresponding to each pressure chamber 23 is driven by supply of a drive signal from a printer controller side which is not shown. Thereby, a change in pressure of the ink in each pressure chamber 23 is generated, and ink droplets are ejected (discharged) from the associated nozzle 29 by controlling the generated change in the pressure.

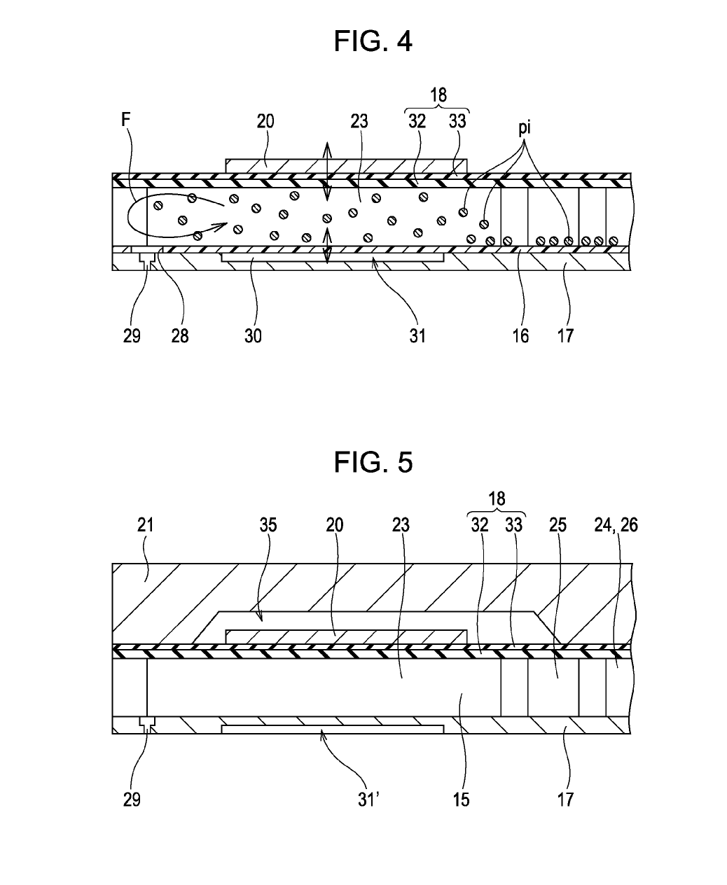

In this case, when the change in the pressure of the ink in the pressure chamber 23 is generated by driving the associated piezoelectric device, the deformation portion 31 is vibrated in an upward and downward direction as shown in FIG. 4. As a result, for example, the flow F may be generated in the pressure chamber 23, and the pigments pi (for example, a metal piece which is made of metal, such as titanium dioxide (TiO₂) used as a white pigment oraluminum used as a brilliant pigment, etc.) settled at the bottom thereof may be agitated. Accordingly, the pigments pi are dispersed, and thus it may be possible to suppress variation in the concentration of the pigments in the discharged ink droplets. Moreover, the agitation of the ink in the pressure chamber 23 is not limited to being generated when the ink droplets are ejected from the associated nozzle 29. Therefore, the agitation of the ink in the pressure chamber 23 may be generated even when the ink droplets are not ejected from the nozzle 29. For example, the piezoelectric device 20 is driven and generates a minute vibration to the extent of not ejecting the ink droplets from the nozzle 29, thereby vibrating the deformation portion 31.

As described above, at least a portion of the bottom of the pressure chamber 23 is provided with the deformation portion 31 which is deformed in response to the change in the pressure of the ink in the pressure chamber 23. Therefore, the change in the pressure of the ink in the pressure chamber 23 allows the change of the deformation portion 31 and the agitation of the ink in the pressure chamber 23 to be generated. As a result, the pigments pi may be prevented from being settled to the bottom. Also, even when the pigments pi are settled at the bottom, the settled pigments pi may be agitated. Furthermore, in the deformation portion 31 of the embodiment, since the configuration is adopted in which the lower vibration plate 16 seals the opening portion of the empty portion 30 formed at a portion of the section corresponding to the pressure chamber 23 of the nozzle plate 17, it may be possible to simply realize the configuration to agitate the pigments pi settled at the bottom.

Although at least a portion of the bottom of the pressure chamber 23 has been provided with the deformation portion 31 which is deformed in response to the change in the pressure of the ink in the pressure chamber 23, the embodiment is not limited thereto. For example, in a second embodiment shown in FIG. 5, a deformation portion 31′ is formed at the nozzle plate 17 itself without provision of the lower vibration plate 16.

Specifically, the bottom of each of the pressure chambers 23 is formed by the nozzle plate 17 having the opened nozzles 29, a section having a thinner thickness than the other section is formed as the deformation portion 31′ in a portion of the bottom. For example, in the case where the nozzle plate 17 is a silicon single crystal substrate of approximately 100 μm in thickness, since the section corresponding to the deformation portion 31′ is recessed from an opposite side to the pressure chamber 23 by etching and has a thickness of approximately 40 μm, the section may become the deformation portion 31′. Moreover, the deformation portion 31′ is formed in a rectangular shape along the longitudinal direction of the pressure chamber 23 when viewed from the top between each ink supply passage 25 and each nozzle 29, similarly as the first embodiment.

As described above, the deformation portion 31′ is formed of the section having the thinner thickness than the other section in the nozzle plate 17. Therefore, there may be no need to form the deformation portion 31′ by adding a new member and the like (for example, the lower vibration plate 16) to the recording head of the related art, and it may be possible to further simply realize the configuration to agitate the pigments and the like settled at the bottom. Also, since the other configurations are the same as the first embodiment, the description thereof will be omitted.

Here, the invention is not limited to the above-mentioned embodiments, but various modifications may be possible based on the following claims. For example, although being formed in the rectangular shape (that is, the concave portion of the rectangular parallelepiped shape) along the longitudinal direction of the pressure chamber when viewed from the top, the deformation portion is not limited thereto and may be formed in any shape. Also, a plurality of deformation portions may be provided in one pressure chamber. In brief, the deformation portion may have a shape capable of being easily agitated according to the shape of the pressure chamber, as long as it is provided at the bottom of the pressure chamber.

In the above-mentioned embodiments, although the so-called flexural vibration type piezoelectric vibrator has been exemplified as the pressure generation unit, the invention is not limited thereto. For example, the invention may adopt a so-called vertical vibration type piezoelectric vibrator. Furthermore, the invention may be applied even when various pressure generation units, such as a heating device to generate bubbles in a pressure chamber and an electrostatic actuator to change a capacity of the pressure chamber using an electrostatic force, are utilized, in addition to the piezoelectric vibrator as the pressure generation unit.

The invention is not limited to the printer, but may also be applied to various ink jet type recording apparatuses such as a plotter, a facsimile apparatus, and a copy machine, or liquid ejecting heads which are used for liquid ejecting apparatuses such as a display manufacturing apparatus, an electrode manufacturing apparatus, and a chip manufacturing apparatus, other than the recording apparatuses, as long as the liquid ejecting heads of the liquid ejecting apparatuses are able to control the ejection of liquids using the pressure generation unit. In the display manufacturing apparatus, solutions of color materials of R (Red), G (Green), and B (Blue) are ejected from a color material ejecting head. Also, in the electrode manufacturing apparatus, a liquid-phase electrode material is ejected from an electrode material ejecting head. Furthermore, in the chip manufacturing apparatus, a solution of a bio-organic substance is ejected from a bio-organic substance ejecting head.

What is claimed is:

1. A liquid ejecting head in which a liquid is able to be filled in a pressure chamber communicated with a nozzle and droplets are able to be ejected from the nozzle by applying a change in pressure of the liquid in the pressure chamber,
wherein the pressure chamber has a deformation portion which is deformed based on the change in the pressure of the liquid in the pressure chamber, in at least a portion of a bottom thereof.

2. The liquid ejecting head according to claim 1,
wherein the bottom of the pressure chamber is formed by a nozzle plate in which the nozzle is opened and a flexible vibration plate which is laminated in at least a portion between the nozzle plate and the pressure chamber,
wherein a concave portion is formed in at least a portion corresponding to the pressure chamber in the nozzle plate, and
wherein the deformation portion is formed by sealing the concave portion with the vibration plate.

3. The liquid ejecting head according to claim 1,
wherein the bottom of the pressure chamber is formed by a nozzle plate in which the nozzle is opened, and
wherein the deformation portion is formed of a section having a thinner thickness than the other section in the nozzle plate.

4. A liquid ejecting apparatus comprising the liquid ejecting head according to claim 1.

5. A liquid ejecting apparatus comprising the liquid ejecting head according to claim 2.

6. A liquid ejecting apparatus comprising the liquid ejecting head according to claim 3.
